(19) United States
(12) Patent Application Publication
(10) Pub. No.: US 2022/0277110 A1
(43) Pub. Date: Sep. 1, 2022

(54) SECURE COMPUTATION SYSTEM, SECURE COMPUTATION METHOD, AND SECURE COMPUTATION PROGRAM

(71) Applicant: NEC Corporation, Minato-ku, Tokyo (JP)

(72) Inventor: Takao TAKENOUCHI, Tokyo (JP)

(73) Assignee: NEC Corporation, Minato-ku, Tokyo (JP)

(21) Appl. No.: 17/631,079

(22) PCT Filed: Aug. 7, 2019
(86) PCT No.: PCT/JP2019/031057

§ 371 Date: Jan. 28, 2022

(51) Int. Cl. G06F 21/78; G06F 21/60; G06F 21/62; H04L 67/1097

(52) U.S. Cl. CPC G06F 21/78; G06F 21/602; G06F 21/6245; H04L 67/1097

(57) ABSTRACT

A secure computation system comprises a secured cache that stores a result of a computation process using secured data while maintaining the result in secret; a normal cache that stores a result of a computation process using secured data without maintaining the secret processing; and a first confidentiality determination part that determines whether to store the result of the computation process in the secured cache or in the normal cache.

### TECHNICAL FIELD

The present invention relates to a secure computation system, secure computation method, and secure computation program.

### BACKGROUND

A secure computation scheme is a technology capable of providing a computation result while concealing the computation process from a third party involved. In a secure computation scheme, an operation is executed on data held in a server managed by a third party such as a cloud server. Further, as a secure computation scheme, a basic processing method for executing any computation is known. This can be used when an analysis of sensitive information such as personal information is outsourced since a third party does not have access to the data or computation process that is the basis of the computation.

As a typical secure computation method, a scheme using secret sharing and one using homomorphic encryption are known. In the secret sharing scheme, confidential information is divided into data called shares and stored in a plurality of servers. Then, an arbitrary computation can be executed using the divided data, i.e., the data that remains confidential, in the secret sharing scheme. Non-Patent Literature 1 describes a typical example of a computation method in a secret sharing scheme. Further, a homomorphic encryption scheme can also execute computation using data that remains confidential. Non-Patent Literature 2 describes a typical example of a computation method in a homomorphic encryption scheme.

### CITATION LIST

### Non-Patent Literature

Non-Patent Literature 1: M. Ben Or, S. Goldwasser, and A. Wigderson, “Completeness Theorems for Non-Cryptographic Fault-Tolerant Distributed Computation (Extended Abstract).”
Non-Patent Literature 2: T. E. Gamal, “A Public Key Cryptosystem and a Signature Scheme Based on Discrete Logarithms,” IEEE Transactions on Information Theory, 31(4) 469-472, 1985.

### SUMMARY

### Technical Problem

The disclosure of each Non-Patent Literature cited above is incorporated herein in its entirety by reference thereto. The following analysis is given by the present inventors.

Since the amount of communication is large in a secure computation scheme, it is several tens to several hundred times slower than a conventional computation method. In secure computation using secret sharing, in particular, since confidential information is divided into data called shares and stored in a plurality of servers, the amount of communication increases significantly among the plurality of servers.

Caching is known as a general technique for reducing the amount of communication between servers and for effectively utilizing intermediate computation results. In secure computation, however, the size of secured data is generally larger than that of data not processed with secret processing, and a large cache capacity is required. Further, in secure computation using secret sharing, since each server must have a cache, the cache capacity simply increases by the number of shares obtained by dividing confidential information.

In view of the above problems, it is an object of the present invention to provide a secure computation system, secure computation method, and secure computation program that contribute to reducing the amount of cache required.

### Solution to Problem

According to a first aspect of the present invention, there is provided a secure computation system comprising a secured cache that stores the result of a computation process using secured data while maintaining the result in secret; a normal cache that stores the result of a computation process using secured data without maintaining the result in secret; and a first confidentiality determination part that determines whether to store the result of the computation process in the secured cache or in the normal cache.

According to a second aspect of the present invention, there is provided a secure computation method using a secure computation system comprising a secured cache that stores a result of a computation process using secured data while maintaining the result in secret and a normal cache that stores a result of a computation process using secured data without maintaining the secret processing, the secure computation method including a secure computation step of performing a computation process using secured data; and a confidentiality determination step of determining whether to store the result of the secure computation step in the secured cache or in the normal cache.

According to a third aspect of the present invention, there is provided a secure computation program executed by a secure computation system comprising a secured cache that stores a result of a computation process using secured data while maintaining the result in secret and a normal cache that stores a result of a computation process using secured data without maintaining the result in secret, the secure computation program including a secure computation step of performing a computation process using secured data; and a confidentiality determination step of determining whether to store a result of the secure computation step in the secured cache or in the normal cache.

Further, this program can be stored in a computer-readable storage medium. The storage medium may be a non-transient one such as a semiconductor memory, a hard disk, a magnetic recording medium, an optical recording medium, and the like. The present invention can also be realized as a computer program product.

### Advantageous Effects of Invention

According to each aspect of the present invention, there can be provided a secure computation system, secure computation method, and secure computation program that contribute to reducing the amount of cache required.

### BRIEF DESCRIPTION OF DRAWINGS

FIG. 1 is a drawing illustrating a schematic configuration of a secure computation system relating to a first example embodiment.

FIG. 2 is a drawing showing an example of the procedure of a secure computation method.

FIG. 3 is a drawing showing an example of the procedure of the secure computation method.

FIG. 4 is a drawing showing an example of the entire procedure of the secure computation method.

FIG. 5 is a drawing showing confidential data used to describe a concrete example.

FIG. 6 is a drawing showing data that should be held in a secured cache.

FIG. 7 is a drawing illustrating a schematic configuration of a secure computation system relating to a second example embodiment.

FIG. 8 is a drawing illustrating an example of the hardware configuration of each server.

### MODES

Example embodiments of the present invention will be described with reference to the drawings. The present invention, however, is not limited to the example embodiments described below. Further, in each drawing, the same or corresponding elements are appropriately designated by the same reference signs. It should be noted that the drawings are schematic, and the dimensional relationships and the ratios between the elements may differ from the actual ones. The dimensional relationships and the ratios between drawings may also be different in some sections.

### First Example Embodiment

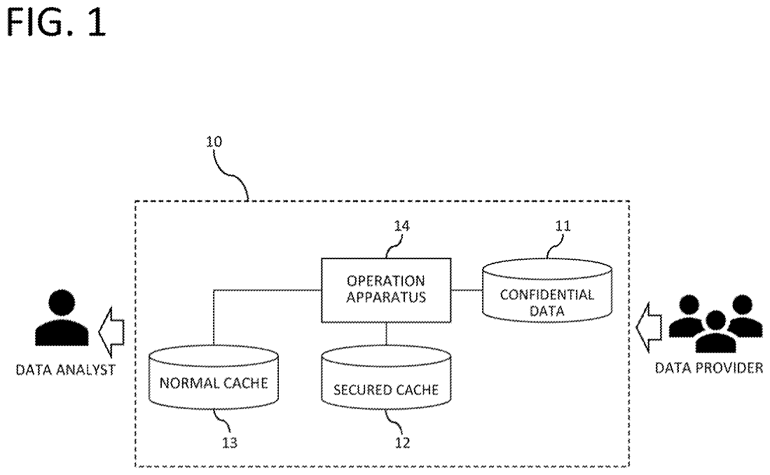

FIG. 1 is a drawing illustrating a schematic configuration of a secure computation system relating to a first example embodiment. As shown in FIG. 1, the secure computation system 10 comprises a confidential data storage 11, a secured cache 12, a normal cache 13, and an operation apparatus 14. The secure computation system 10 is able to compute confidential data provided by a data provider while maintaining the confidentiality of the data and provide only the computation results to a data analyst while maintaining the confidentiality of the content of the confidential data and the computation process.

The data analyst may also be one of the data providers. In other words, when the data providers are A, B, and C, A may be the data analyst. In this case, A is able to analyze data including the one provided by B and C without knowing the content of the data provided by B and C.

The confidential data storage 11 is a storage device that stores confidential data provided by a data provider while maintaining the confidentiality of the data. For instance, the confidential data provided by a data provider may be personal information. The content of confidential data, however, is not necessarily limited to personal information, and data that is desired to be confidential can be treated as confidential data.

For instance, in a secret sharing scheme, the confidential data storage 11 divides the confidential data provided by a data provider into data called shares and stores them in a plurality of servers. Note that, although FIG. 1 shows the confidential data storage 11 as a single device, the drawing illustrates function blocks and not physical entities. On the other hand, for instance, in a homomorphic encryption scheme, the confidential data storage 11 may be configured as a storage device provided in a single server.

The secured cache 12 is a storage device configured to store the result of a computation process using the confidential data stored in the confidential data storage 11 while maintaining the confidentiality of the computation result. The secured cache 12 may be provided by using a part of the storage area of the confidential data storage 11 or may be provided as a storage device physically separate from the confidential data storage 11. When the secured cache 12 is configured as a storage device physically separate from the confidential data storage 11, it is possible to employ a configuration suitable for achieving a cache function, for instance, providing the secured cache 12 with faster read/write speed.

Further, when storing the result of a computation process using the confidential data stored in the confidential data storage 11 and maintaining the confidentiality of the result, the secured cache 12 associates the computation result with the computation process. Then, the secured cache 12 stores the data so as to be able to retrieve the computation result using the computation process as a search key.

The normal cache 13 is a normal storage device that stores the result of a computation process using the confidential data stored in the confidential data storage 11 without maintaining the confidentiality of the computation result. What this means is that the normal cache 13 does not execute the secret processing performed on the confidential data stored in the confidential data storage 11. That is to say, the normal cache 13 may execute secret processing different from the one performed on the confidential data. In other words, data held by the normal cache 13 is not limited to so-called plaintext. For instance, the secured cache 12 and the normal cache 13 may perform different types of secret processing with different encryption strengths.

Further, the normal cache 13 may be provided by using a part of the storage area of the confidential data storage 11 or may be provided as a storage device physically separate from the confidential data storage 11. For instance, in a homomorphic encryption scheme, the normal cache 13 should not encrypt the data using homomorphic encryption, and data not encrypted with homomorphic encryption can be cached in a part of the storage area of the confidential data storage 11. On the other hand, in a secret sharing scheme, the confidential data storages 11 and the secured cache 12 are provided in a plurality of servers. Therefore, it is preferable to provide the normal cache 13 in a computation apparatus different from a server comprising a secured cache 12, without excluding the possibility of providing it in one of the servers comprising a secured cache 12.

When storing the result of a computation process using the confidential data stored in the confidential data storage 11 and maintaining the confidentiality of the result, the normal cache 13 associates the computation result with the computation process. Then, the normal cache 13 stores the data so as to be able to retrieve the computation result using the computation process as a search key.

The operation apparatus 14 is configured to perform a computation process (so-called secure computation) using secured data. Further, the operation apparatus 14 determines whether to store the result of the computation process in the secured cache 12 or the normal cache 13.

The operation apparatus 14 may be configured by using a general-purpose microprocessor, or a microprocessor specially configured to be able to suitably perform secure computation may be used. Further, the operation apparatus 14 may also be constituted by combining a general-purpose microprocessor and one for secure computation. When the secure computation system 10 is configured within a single server, only one operation apparatus 14 may be provided, however, when the confidential data storage 11 and the secured cache 12 are provided in each of a plurality of servers in a secret sharing scheme, the operation apparatus 14 is provided in each server. In a case where the normal cache 13 is provided in a computation apparatus different from a server comprising a secured cache 12, the operation apparatus 14 is provided in the computation apparatus having the normal cache 13. The operation apparatus 14 provided in the computation apparatus different from a server comprising a secured cache 12 does not need to perform a computation process (so-called secure computation) using secured data but may determine whether to store the result of the computation process in the secured cache 12 or the normal cache 13.

### (Secure Computation Method)

The following describes a secure computation method performed using the secure computation system comprising the secured cache that stores the result of a computation process using secured data while maintaining the confidentiality thereof and the normal cache that stores the computation result without maintaining the confidentiality thereof. The secure computation method described below can be implemented by any secure computation system comprising a secured cache that stores data while maintaining confidentiality and a normal cache that stores data without maintaining confidentiality, however, the method will be described with reference to the configuration of the secure computation system 10 shown in FIG. 1 in order to facilitate the explanation.

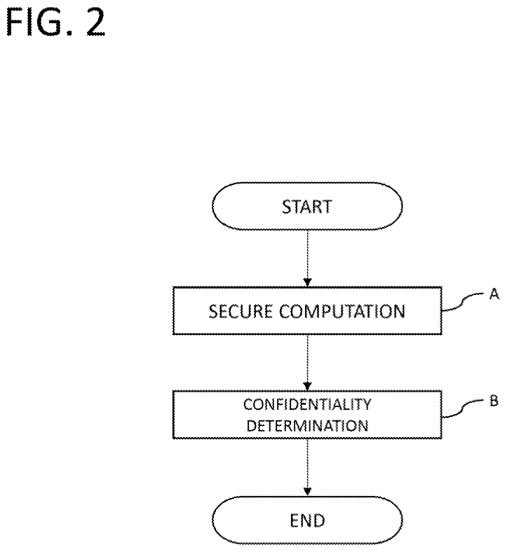

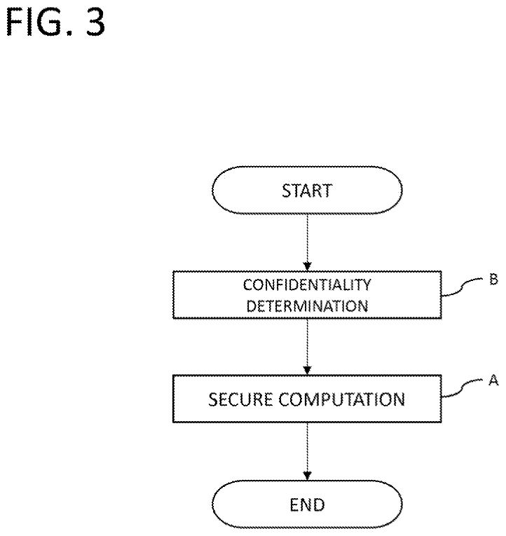

FIGS. 2 and 3 are drawings showing examples of the procedure of the secure computation method. The secure computation method should include a secure computation step (step A) of performing a computation process using confidential data and a confidentiality determination step (step B) of determining whether to store the result of the secure computation step in the secured cache 12 or the normal cache 13, and there are two possibilities for the order of the secure computation step (step A) and the confidentiality determination step (step B).

The confidentiality determination step (step B) may be executed after the secure computation step (step A) as shown in FIG. 2, or the confidentiality determination step (step B) may be executed before the secure computation step (step A) as shown in FIG. 3.

For instance, when secure computation is performed using confidential personal information, one needs to have the computation result first to determine whether or not the result satisfies k-anonymity. Therefore, as shown in FIG. 2, the confidentiality determination step (step B) is executed after the secure computation step (step A). On the other hand, when a mean value or sum value is calculated, the computation result is not needed to make a determination. Therefore, as shown in FIG. 3, the confidentiality determination step (step B) is executed before the secure computation step (step A). In addition to k-anonymity, l-diversity is another example that requires the computation result to make a determination. Further, a method for adding enough noise to satisfy differential privacy is another example that does not require the computation result to make a determination.

k-anonymity means that there are at least k pieces of data having quasi-identifiers (the same attributes). Although this depends on the population, for instance, with an age attribute of 110, k is generally 1 and the corresponding data is personally identifiable information. An age attribute of 80, however, generally and sufficiently increases k. Therefore, one judgment criterion is to regard data corresponding to an age attribute of 85 or older as personally identifiable information, but not data corresponding to an age attribute of 84 or younger. k is generally 1 with maximum and minimum values, and one may not have to regard data as personally identifiable information as long as a value is not equal to or greater than (or less than) a prespecified value for each attribute.

Further, in general, since a mean or sum value with respect to a plurality of people is data from which an individual cannot be identified, one can determine that it is not personally identifiable information. While a mean or sum value with respect to one person is obviously personally identifiable information, it is likely that an individual can be identified from a mean or sum value with respect to two people. One may determine that even a mean or sum value is personally identifiable information unless it is of data with sufficiently large k of k-anonymity (for instance, 10 or greater).

Further, l-diversity requires that data groups with the same quasi-identifier have at least 1 different pieces of information. Since l-diversity also satisfies l-anonymity, it is a stronger judgment criterion than k-anonymity.

As described, since determining whether or not data is personally identifiable information, i.e., determining the confidentiality of data, is an issue that depends on the size of the population and the attributes of the handled data, an administrator or designer of the secure computation system 10 appropriately makes a determination.

Further, when determining whether to store data in the secured cache 12 or the normal cache 13, one may take technical aspects into account, in addition to the nature of confidential data such as personal information. For instance, one may determine whether to store data in the secured cache 12 or the normal cache 13 by using a threshold value according to the capacity of the secured cache 12. Alternatively, data that requires a long computation process time may be preferentially stored in the secured cache 12.

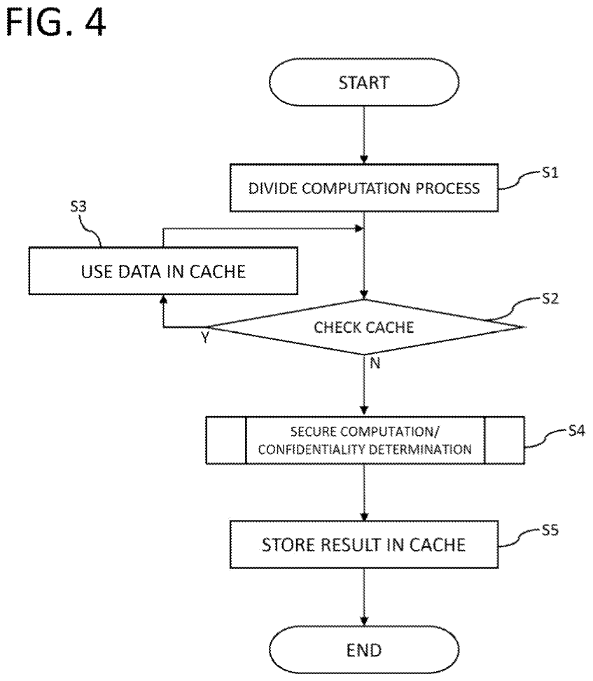

FIG. 4 is a drawing showing an example of the entire procedure of the secure computation method. The secure computation method shown in FIG. 2 or 3 is included as part of the entire procedure of the secure computation method shown in FIG. 4; the included part may be either from FIG. 2 or 3.

As shown in FIG. 4, in the entire procedure of the secure computation method, a computation process is first divided (step S1). A computation process is normally a stack of a plurality of computation processes, and the computation process requested by a data analyst is divided in this step. For instance, a process of computing the number of people satisfying a certain condition can be divided into a process of extracting people satisfying the condition and a process of summing the number of the extracted people.

Then, whether or not the result of each of the divided computation processes as described above is held in the caches is checked (step S2). In this step, both the secured cache 12 and the normal cache 13 are checked. Further, since the secured cache 12 and the normal cache 13 store the result of a computation process in association with the computation process, each divided computation process is used as a search key when the caches are checked.

When the result of a computation process is held in a cache (Yes in the step S2), the computation process result held in the cache is used (step S3). On the other hand, when the result of a computation process is not found in a cache (No in the step S2), secure computation is executed.

Regarding the execution of secure computation and confidentiality determination in step S4, as described above, the confidentiality determination step (step B) may be performed after the secure computation step (step A) as shown in FIG. 2, or the confidentiality determination step (step B) may be performed before the secure computation step (step A) as shown in FIG. 3. In other words, one of the secure computation methods shown in FIGS. 2 and 3 is appropriately executed when secure computation and confidentiality determination are executed in the step S4. Further, since the computation process requested by the data analyst is divided in the step S1, either the secure computation method shown in FIG. 2 or the one in FIG. 3 can be selected for each divided computation process in the step S4 in which secure computation and confidentiality determination are executed.

Then, the result of the step S4 is stored in the secured cache 12 or the normal cache 13 according to the confidentiality determination step (step B) (step S5). Further, the final computation result is not only stored in the secured cache 12 or the normal cache 13 but is also provided to the data analyst.

### (Concrete Example)

The following describes a concrete example of the above secure computation method. The concrete example given here shows the relationships between computation processes and the cache when three computation processes are sequentially requested. Further, the following description refers to the steps shown in FIG. 4 to facilitate the explanation.

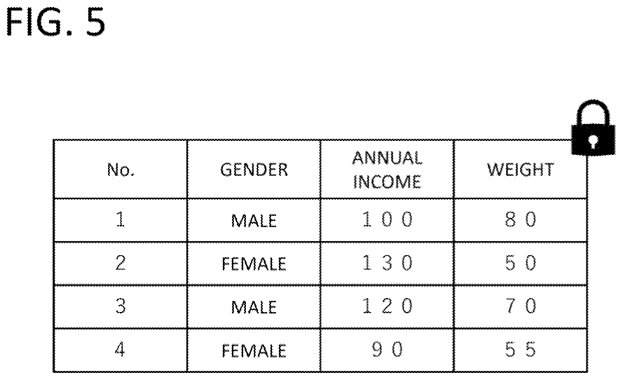

The three requested computation processes are as follows and these requested processes are performed with respect to confidential data shown in FIG. 5.

Requested process A: Calculate the average weight of males with an annual income of 100 or more.
Requested process B: Calculate the average annual income of the males with an annual income of 100 or more.
Requested process C: Calculate the number of the males with an annual income of 100 or more.

First, the requested process A is divided into computation processes (the step S1). Here, for instance, the requested process A is divided as follows.

Computation process A1: Extract males with an annual income of 100 or more.
Computation process A2: Add up the weights of the males with an annual income of 100 or more.
Computation process A3: Add up the number of the males with an annual income of 100 or more.
Computation process A4: Divide the total weight of the males with an annual income of 100 or more by the number of the males with an annual income of 100 or more.

Next, whether or not the result of each computation process is held in the caches is checked (the step S2). Here, however, we'll assume that the requested process A is a first process and the caches do not store the result of any computation process.

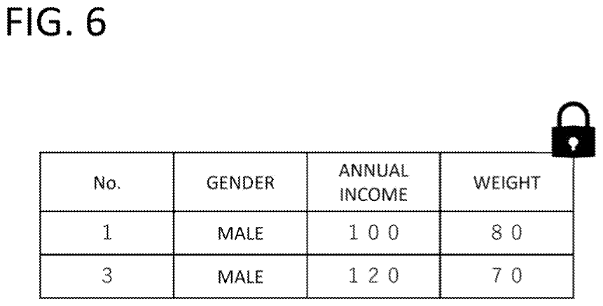

Therefore, secure computation and confidentiality determination are executed for each computation process (the step S4). The result of the computation process A1 is a list shown in FIG. 6, and since this corresponds to personal information, it is determined that the list should be confidential.

The result of the computation process A2 is “150,” and since this is not personal information, one determines that it does not need to be confidential.
The result of the computation process A3 is “2,” and since this is not personal information, one determines that it does not need to be confidential.
The result of the computation process A4 is “75,” and since this is not personal information, one determines that it does not need to be confidential.
As described above, in one judgment criterion, for instance, the result of computation on data from a plurality of people, such as summing and averaging, is not personal information and does not need to be confidential.

Next, the results of the above computation processes are stored in the secured cache 12 or the normal cache 13 (the step S5). More specifically, the result of the computation process A1 is stored in the secured cache 12 since it is personal information, and the results of the computation processes A2 to A4 are stored in the normal cache 13 since they are not personal information. Further, the result of the requested process A is “75,” which is the result of the computation process A4, and this is provided to the data analyst.

We'll assume that the requested process B is called for next. First, the requested process B is divided into computation processes (the step S1). Here, for instance, the requested process B is divided as follows.

Computation process B1: Extract males with an annual income of 100 or more.
Computation process B2: Add up the annual incomes of the males with an annual income of 100 or more.
Computation process B3: Add up the number of the males with an annual income of 100 or more.
Computation process B4: Divide the total annual income of the males with an annual income of 100 or more by the number of the males with an annual income of 100 or more.

Next, whether or not the result of each computation process is held in the caches is checked (the step S2). Here, since the computation processes B1 and B3 are the same as the computation processes A1 and A3, respectively, the results thereof are cached. Therefore, the computation processes B1 and B3 are not executed and the results in the caches are used (the step S3).

On the other hand, since the computation processes B2 and B4 are not cached, secure computation and confidentiality determination are executed (the step S4).

The result of the computation process B2 is “220,” and since this is not personal information, one determines that it does not need to be confidential.
The result of the computation process B4 is “110,” and since this is not personal information, one determines that it does not need to be confidential.

Then, the results of the above computation processes are stored in the secured cache 12 or the normal cache 13 (the step S5). More specifically, the results of the computation processes B2 and B4 are stored in the normal cache 13 since they are not personal information. Further, the result of the requested process B is “110,” which is the result of the computation process B4, and this is provided to the data analyst.

We'll assume that the requested process C is called for next. First, the requested process C is divided into computation processes (the step S1). Here, for instance, the requested process C is divided as follows.

Computation process C1: Extract males with an annual income of 100 or more.
Computation process C2: Add up the number of the males with an annual income of 100 or more.

Next, whether or not the result of each computation process is held in the caches is checked (the step S2). Here, since the computation processes C1 and C2 are the same as the computation processes A1 and A3, respectively, the results thereof are cached. Therefore, the computation processes C1 and C2 are not executed and the results in the caches are used (the step S3).

Since all the divided computation processes in the requested process C have been cached, it is not necessary to execute secure computation and confidentiality determination. The result of the requested process C is “2,” which is the result of the computation process C2, and this is provided to the data analyst.

As described, the secure computation method using the secure computation system 10 comprising the secured cache 12 and the normal cache 13 can contribute to reducing the required cache capacity by determining whether to store the result of a computation process in the secured cache 12 or the normal cache 13. In secure computation, the size of secured data is generally larger than that of data not processed with secret processing, and a large cache capacity is required. Then, by caching in the normal cache 13 the result of a computation process that does not need to be stored in the secured cache 12, the cache capacity of the secured cache 12 and the normal cache 13 as a whole can be reduced.

### Second Example Embodiment

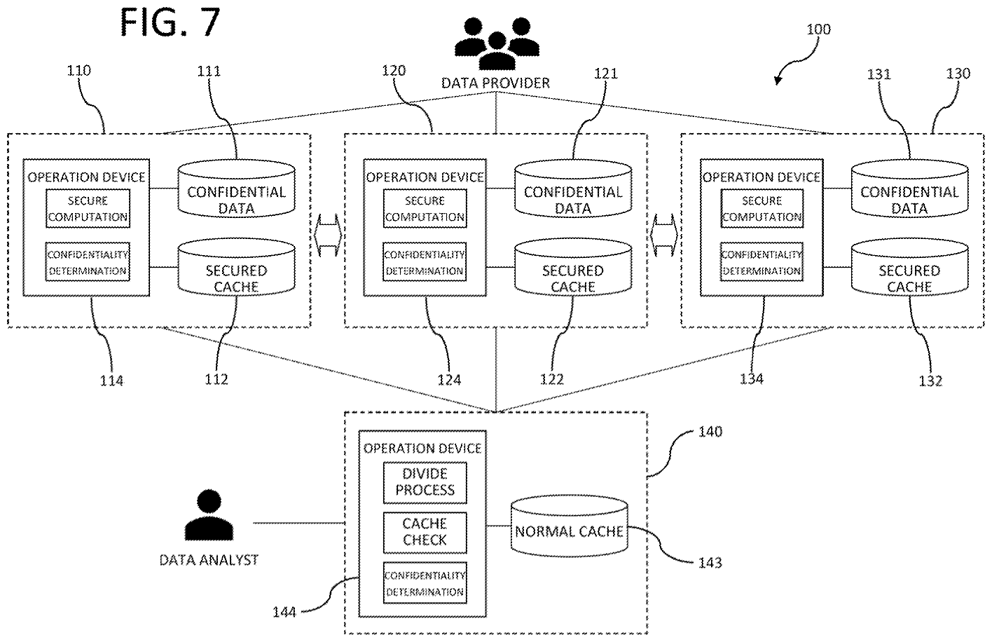

FIG. 7 is a drawing illustrating a schematic configuration of a secure computation system relating to a second example embodiment. As shown in FIG. 7, a secure computation system 100 comprises three secure computation servers 110, 120, and 130, and a front-end server 140. The secure computation system 100 is capable of secretly sharing confidential data provided by a data provider with the three secure computation servers 110, 120, and 130 and providing only the computation result to a data analyst while maintaining the confidentiality of the confidential data content and the computation process. In other words, in the secure computation system 100, the technical concept of the first example embodiment is applied to a secret sharing scheme. It should be noted that, in this example, the number of secure computation servers is three due to space limitations, and the system may be configured to comprise more than three secure computation servers.

As shown in FIG. 7, the secure computation server 110 comprises a confidential data storage 111, a secured cache 112, and an operation device 114. The secure computation server 120 comprises a confidential data storage 121, a secured cache 122, and an operation device 124. Further, the secure computation server 130 comprises a confidential data storage 131, a secured cache 132, and an operation device 134.

The confidential data storages 111, 121, and 131 are storage devices that store confidential data provided by the data provider while maintaining the confidentiality of the data. For instance, the confidential data provided by the data provider may be personal information. The content of confidential data, however, is not necessarily limited to personal information, and data that is desired to be confidential can be treated as confidential data. The secure computation system 100 divides the confidential data provided by the data provider into data called shares and stores them in each of the confidential data storages 111, 121, and 131.

The secured caches 112, 122, and 132 are storage devices configured to store the result of a computation process using the confidential data stored in the confidential data storages 111, 121, and 131 while still secretly sharing the computation result. The secured caches 112, 122, and 132 may be provided by using parts of the storage areas of the confidential data storages 111, 121, and 131 or may be provided as storage devices physically separate from the confidential data storages 111, 121, and 131. When the secured caches 112, 122, and 132 are configured as storage devices physically separate from the confidential data storages 111, 121, and 131, it is possible to employ a configuration suitable for achieving a cache function, for instance, providing the secured caches 112, 122, and 132 with faster read/write speed.

Further, when storing the result of a computation process using the confidential data stored in the confidential data storages 111, 121, and 131 while still secretly sharing the computation result, the secured caches 112, 122, and 132 associate the computation result with the computation process. Then, the secured caches 112, 122, and 132 store the data so as to be able to retrieve the computation result using the computation process as a search key.

The operation devices 114, 124, and 134 are configured to perform a computation process (so-called secure computation) using secretly shared data. Further, the operation devices 114, 124, and 134 determine whether to store the result of the computation process in the secured caches 112, 122, and 132 or a normal cache 143. For instance, when secure computation is performed using confidential personal information, one needs to have the computation result first to determine whether or not the result satisfies k-anonymity. Therefore, the operation devices 114, 124, and 134 perform confidentiality determination in the secure computation servers 110, 120, and 130.

The front-end server 140 is a computation apparatus that comprises the normal cache 143 and an operation device 144.

The normal cache 143 is a normal storage device that stores the result of a computation process using the confidential data stored in the confidential data storages 111, 121, and 131 without performing secret sharing. Here, data held by the normal cache 143 is not limited to so-called plaintext. For instance, it is possible to use an encryption scheme that does not utilize secret sharing. Further, the normal cache 143 may be provided by using a part of the storage area of the front-end server 140.

When storing the result of a computation process using the confidential data stored in the confidential data storages 111, 121, and 131 while still secretly sharing the computation result, the normal cache 143 associates the computation result with the computation process. Then, the normal cache 143 stores the data so as to be able to retrieve the computation result using the computation process as a search key.

The operation device 144 performs general processing as a computation device such as dividing a computation process requested by a data analyst and checking whether or not the result of each divided computation process is held in a cache. Further, the operation device 144 determines whether to store the computation result in the secured caches 112, 122, and 132 or the normal cache 143. For instance, when calculating a mean value or sum value, the operation device 144 does not need a computation result to perform confidentiality determination. Therefore, the operation device 144 performs confidentiality determination within the front-end server 140.

The following describes a secure computation example in a secret sharing scheme applicable to the configuration of the secure computation system 100. Note that a secure computation example in a secret sharing scheme applicable to the configuration of the secure computation system 100 is not limited to the description below, and it is possible to select, improve, and use secure computation in a general secret sharing scheme according to the purpose of use.

Here, a secret S, which is a value over a field, is shared by a plurality of secure computation servers using a polynomial F over this field where F(0)=S. At this time, information with respect to the input and output of a function cannot be obtained when the number of the secure computation servers is N and the number of secrets is less than K. Assign a different value over the field to each secure computation server and let a value over the field assigned to the i-th device be X[i] (where 1≤i≤N).

When a secret A is shared by the plurality of secure computation servers, F[i]: =F(X[i]) relating to a randomly selected (K−1)-th degree polynomial F such that F(0)=A is distributed to the i-th device. With respect to a secret B, similarly, G[i]: =G(X[i]) relating to a (K−1)-th degree polynomial G such that G(0)=B is distributed to the i-th secure computation server. Here, in order to know the secrets, when there are K or more devices, it becomes possible to solve the (K−1)-th degree polynomials, derive the coefficients of F and G, and calculate F(0) and G(0).

In order to calculate the addition of the secrets A and B (A+B) from the values distributed to each secure computation server, each i-th device calculates H[i]=F[i]+G[i]. Since this value is equal to a value H(X[i]) obtained by plugging X[i] into a polynomial H whose coefficient is the sum of the coefficient corresponding to each of the polynomials F and G, like the secret A or B, it is equal to A+B distributed to the plurality of secure computation servers. As with the secret A or B, if there are K or more secure computation servers, it is possible to solve a (K−1)-th degree polynomial, obtain the coefficient of H, and calculate H(0).

Further, under the condition of K*2≤N+1, in order to calculate the multiplication of the secrets A and B (A*B) using the shared values, each i-th secure computation server calculates H[i]=F[i]*G[i]. Since this value is equal to a value H(X[i]) obtained by plugging X[i] into a 2K-th degree polynomial H(X)=F(X)*G(X), like the secret A or B, it is equal to A*B distributed to the plurality of secure computation servers. Note that, unlike the case of the secret A or B, since the degree of H is 2K, it is possible to solve a 2K-th degree polynomial, obtain the coefficient of H, and calculate H(0) if there are 2K or more secure computation servers. As described, the method for distributing A*B is different from that for distributing the secret A or B.

In order to distribute A*B using a (K−1)-th polynomial as with the secret A or B, each i-th device generates a (K−1)-th polynomial G from H[i] and distributes G[X(j)] to the other j-th device. As described, in secure computation in a secret sharing scheme, all functions consisting of addition and multiplication can be computed.

In secure computation in a secret sharing scheme, it is possible to obtain the result of computation on the original data by performing computation on data obtained by dividing the original data. In other words, the result of computation on the original data can be obtained by combining the result of computation performed by each secure computation server. In principle, since the original data cannot be reconstructed from each piece of the divided data, this scheme is robust against an untrusted administrator of a particular secure computation server. Further, since there is no need to reconstruct the data during the computation process, it is also robust against leaks while the computation is taking place.

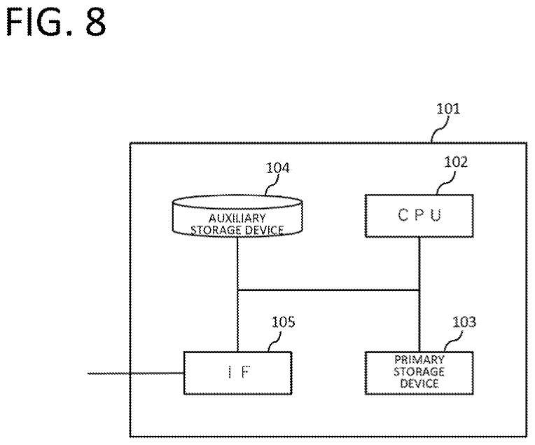

FIG. 8 is a drawing illustrating an example of the hardware configuration of each server. In other words, FIG. 8 shows an example of the hardware configuration of the secure computation servers 110, 120, and 130, and the front-end server 140 included in the secure computation system 100. An information processing apparatus employing the hardware configuration shown in FIG. 8 can achieve the functions of the secure computation servers 110, 120, and 130, and the front-end server 140 included in the secure computation system 100 by executing the secure computation method shown in FIG. 4 as a program.

It should be noted that the hardware configuration example shown in FIG. 8 is merely an example of the hardware configuration that achieves the functions of the secure computation servers 110, 120, and 130, and the front-end server 140 and is not intended to limit the hardware configuration of the secure computation servers 110, 120, and 130, and the front-end server 140. The secure computation servers 110, 120, and 130, and the front-end server 140 may include hardware not shown in FIG. 8.

As shown in FIG. 8, the hardware configuration 101 that may be employed by the secure computation servers 110, 120, and 130, and the front-end server 140 comprises a CPU (Central Processing Unit) 102, a primary storage device 103, an auxiliary storage device 104, and an IF (interface) part 105. These elements are connected to each other by, for instance, an internal bus.

The CPU 102 executes various programs such as a secure computation program executed by the secure computation servers 110, 120, and 130, and the front-end server 140. The primary storage device 103 is, for instance, a RAM (Random Access Memory) and temporarily stores the various programs such as the secure computation program executed by the secure computation servers 110, 120, and 130, and the front-end server 140 so that the CPU 102 can process it.

The auxiliary storage device 104 is, for instance, an HDD (Hard Disk Drive) and is capable of storing the various programs such as the secure computation program executed by the secure computation servers 110, 120, and 130, and the front-end server 140 in the medium to long term. The various programs such as the secure computation program may be provided as a program product stored in a non-transitory computer-readable storage medium. The auxiliary storage device 104 can be used to store the various programs such as the secure computation program stored in a non-transitory computer-readable storage medium over the medium to long term.

The IF part 105 provides an interface to the input and output between the servers.

The information processing apparatus employing the hardware configuration 101 described above can achieve the functions of the secure computation servers 110, 120, and 130, and the front-end server 140 included in the secure computation system 100 by executing the secure computation method shown in FIG. 4 as a program.

Some or all of the example embodiments above can be described as (but not limited to) the following Supplementary Notes.

### [Supplementary Note 1]

A secure computation system comprising:

a secured cache that stores the result of a computation process using secured data while maintaining the result in secret;

a normal cache that stores the result of a computation process using secured data without maintaining the result in secret; and

a first confidentiality determination part that determines whether to store the result of the computation process in the secured cache or in the normal cache.

### [Supplementary Note 2]

The secure computation system according to Supplementary Note 1, wherein

the secured data is secretly shared by a plurality of servers, and

the secured cache is provided in each of the plurality of servers.

### [Supplementary Note 3]

The secure computation system according to Supplementary Note 2, wherein

the first confidentiality determination part is provided in each of the plurality of servers.

### [Supplementary Note 4]

The secure computation system according to any one of Supplementary Notes 1 to 3, wherein

the normal cache is provided in a computation apparatus different from a server comprising the secured cache.

### [Supplementary Note 5]

The secure computation system according to Supplementary Note 4, wherein

a server comprising the normal cache also comprises a second confidentiality determination part that determines whether to store the result of the computation process in the secured cache or in the normal cache.

### [Supplementary Note 6]

The secure computation system according to any one of Supplementary Notes 1 to 5, wherein

the secured cache and the normal cache store the result of the computation process in association with the computation process.

### [Supplementary Note 7]

The secure computation system according to any one of Supplementary Notes 1 to 6, wherein

the first confidentiality determination part determines whether to store the result of the computation process in the secured cache or in the normal cache on the basis of whether or not the result of the computation process is personally identifiable information.

### [Supplementary Note 8]

The secure computation system according to any one of Supplementary Notes 1 to 6, wherein

the first confidentiality determination part determines whether to store the result of the computation process in the secured cache or in the normal cache on the basis of whether or not the result of the computation process satisfies k-anonymity.

### [Supplementary Note 9]

The secure computation system according to any one of Supplementary Notes 1 to 6, wherein

the first confidentiality determination part determines whether to store the result of the computation process in the secured cache or in the normal cache on the basis of whether or not the result of the computation process satisfies l-diversity.

### [Supplementary Note 10]

The secure computation system according to any one of Supplementary Notes 1 to 6, wherein

the first confidentiality determination part determines whether to store data in the secured cache or in the normal cache using a threshold value according to the capacity of the secured cache.

### [Supplementary Note 11]

The secure computation system according to any one of Supplementary Notes 1 to 6, wherein

the first confidentiality determination part makes a determination so as to preferentially store data that requires a long processing time for the computation process in the secured cache.

### [Supplementary Note 12]

A secure computation method using a secure computation system comprising a secured cache that stores the result of a computation process using secured data while maintaining the secret processing and a normal cache that stores the result without maintaining the secret processing, the secure computation method including:

a secure computation step of performing a computation process using the secured data; and

a confidentiality determination step of determining whether to store the result of the secure computation step in the secured cache or in the normal cache.

### [Supplementary Note 13]

The secure computation method according to Supplementary Note 12, wherein the confidentiality determination step is performed after the secure computation step.

### [Supplementary Note 14]

The secure computation method according to Supplementary Note 12, wherein the confidentiality determination step is performed before the secure computation step.

### [Supplementary Note 15]

A secure computation program executed by a secure computation system comprising a secured cache that stores the result of a computation process using secured data while maintaining the result in secret and a normal cache that stores a result of a computation process using secured data without maintaining the result in secret, the secure computation program including:

a secure computation step of performing a computation process using secure data; and

a first confidentiality determination step of determining whether to store the result of the secure computation step in the secured cache or in the normal cache.

### [Supplementary Note 16]

The secure computation program according to Supplementary Note 15, wherein

the secured data is secretly shared by a plurality of servers, and

the secured cache is provided in each of the plurality of servers.

### [Supplementary Note 17]

The secure computation program according to Supplementary Note 16, wherein

each of the plurality of servers executes the first confidentiality determination step.

### [Supplementary Note 18]

The secure computation program according to any one of Supplementary Notes 15 to 17, wherein

the normal cache is provided in a computation apparatus different from a server comprising the secured cache.

### [Supplementary Note 19]

The secure computation program according to Supplementary Note 18, wherein

the computation apparatus includes a second confidentiality determination step of determining whether to store the result of the secure computation step in the secured cache or in the normal cache.

### [Supplementary Note 20]

The secure computation program according to any one of Supplementary Notes 15 to 19 including a cache step of storing the result of the computation process in association with the secure computation step in the secured cache or in the normal cache.

### [Supplementary Note 21]

The secure computation program according to any one of Supplementary Notes 15 to 20, wherein

the first confidentiality determination step determines whether to store the result of the secure computation step in the secured cache or in the normal cache on the basis of whether or not the result of the secure computation step is personally identifiable information.

### [Supplementary Note 22]

The secure computation program according to any one of Supplementary Notes 15 to 20, wherein

the first confidentiality determination step determines whether to store the result of the secure computation step in the secured cache or in the normal cache on the basis of whether or not the result of the secure computation step satisfies k-anonymity.

### [Supplementary Note 23]

The secure computation program according to any one of Supplementary Notes 15 to 20, wherein

the first confidentiality determination step determines whether to store the result of the secure computation step in the secured cache or in the normal cache on the basis of whether or not the result of the secure computation step satisfies l-diversity.

### [Supplementary Note 24]

The secure computation program according to any one of Supplementary Notes 15 to 20, wherein

the first confidentiality determination step determines whether to store data in the secured cache or in the normal cache using a threshold value according to the capacity of the secured cache.

### [Supplementary Note 25]

The secure computation program according to any one of Supplementary Notes 15 to 20, wherein

the first confidentiality determination step makes a determination so as to preferentially store data that requires a long processing time for the computation process in the secured cache.

Further, the disclosure of each Non-Patent Literature cited above is incorporated herein in its entirety by reference thereto and can be used as a basis or a part of the present invention as needed. It is to be noted that it is possible to modify or adjust the example embodiments or examples within the scope of the whole disclosure of the present invention (including the Claims) and based on the basic technical concept thereof. Further, it is possible to variously combine or select (or partially remove) a wide variety of the disclosed elements (including the individual elements of the individual claims, the individual elements of the individual example embodiments or examples, and the individual elements of the individual figures) within the scope of the whole disclosure of the present invention. That is, it is self-explanatory that the present invention includes any types of variations and modifications to be done by a skilled person according to the whole disclosure including the Claims, and the technical concept of the present invention. Particularly, any numerical ranges disclosed herein should be interpreted that any intermediate values or subranges falling within the disclosed ranges are also concretely disclosed even without specific recital thereof.

### REFERENCE SIGNS LIST

10, 100: secure computation system
101: hardware configuration
102: CPU
103: primary storage device
104: auxiliary storage device
105: IF part
11, 111, 121, 131: confidential data storage
12, 112, 122, 132: secured cache
13, 143: normal cache
14: operation apparatus
114, 124, 134, 144: operation device
110, 120, 130: secure computation server
140: front-end server

What is claimed is:

1. A secure computation system comprising:
a secured cache that stores a result of a computation process using secured data while maintaining the result in secret;
a normal cache that stores a result of a computation process using secured data without maintaining the result in secret; and
a first confidentiality determination part that determines whether to store a result of the computation process in the secured cache or in the normal cache.

2. The secure computation system according to claim 1, wherein
the secured data is secretly shared by a plurality of servers, and
the secured cache is provided in each of the plurality of servers.

3. The secure computation system according to claim 2, wherein
the first confidentiality determination part is provided in each of the plurality of servers.

4. The secure computation system according to claim 1, wherein
the normal cache is provided in a computation apparatus different from a server comprising the secured cache.

5. The secure computation system according to claim 4, wherein
a server comprising the normal cache also comprises a second confidentiality determination part that determines whether to store a result of the computation process in the secured cache or in the normal cache.

6. The secure computation system according to claim 1, wherein
the secured cache and the normal cache store a result of the computation process in association with the computation process.

7. The secure computation system according to claim 1, wherein
the first confidentiality determination part determines whether to store the result of the computation process in the secured cache or in the normal cache on the basis of whether or not the result of the computation process is personally identifiable information.

8. The secure computation system according to claim 1, wherein
the first confidentiality determination part determines whether to store the result of the computation process in the secured cache or in the normal cache on the basis of whether or not the result of the computation process satisfies k-anonymity.

9. The secure computation system according to claim 1, wherein
the first confidentiality determination part determines whether to store the result of the computation process in the secured cache or in the normal cache on the basis of whether or not the result of the computation process satisfies l-diversity.

10. The secure computation system according to claim 1, wherein
the first confidentiality determination part determines whether to store data in the secured cache or in the normal cache using a threshold value according to the capacity of the secured cache.

11. The secure computation system according to claim 1, wherein
the first confidentiality determination part makes a determination so as to preferentially store data that requires a long processing time for the computation process in the secured cache.

12. A secure computation method using a secure computation system comprising a secured cache that stores a result of a computation process using secured data while maintaining the result in secret and a normal cache that stores a result of a computation process using secured data without maintaining the result in secret, the secure computation method including:
performing a computation process using secured data; and
determining whether to store a result of the computation process in the secured cache or in the normal cache.

13. The secure computation method according to claim 12, wherein the determining is performed after the computation process.

14. The secure computation method according to claim 12, wherein the determining is performed before the computation process.

15. A non-transient computer readable medium storing a secure computation program executed by a secure computation system comprising a secured cache that stores the result of a computation process using secured data while maintaining the secret processing and a normal cache that stores the result of a computation process using secured data without maintaining the secret processing, the secure computation program including:
performing a computation process using secured data; and
determining whether to store a result of the computation process in the secured cache or in the normal cache.

16. The non-transient computer readable medium storing the secure computation program according to claim 15, wherein
the secured data is secretly shared by a plurality of servers, and
the secured cache is provided in each of the plurality of servers.

17. The non-transient computer readable medium storing the secure computation program according to claim 16, wherein
each of the plurality of servers determines whether to store the result in the secured cache or in the normal cache.

18. The non-transient computer readable medium storing the secure computation program according to claim 15, wherein
the normal cache is provided in a computation apparatus different from a server comprising the secured cache.

19. The non-transient computer readable medium storing the secure computation program according to claim 18, wherein
the computation apparatus determine whether to store the result of the computation process in the secured cache or in the normal cache.

20. The non-transient computer readable medium storing the secure computation program according to claim 15 including storing the result of the computation process in association with the computation process in the secured cache or in the normal cache.

21. The non-transient computer readable medium storing the secure computation program according to claim 15, wherein
the secure computation Program determines whether to store the result of the secure computation step in the secured cache or in the normal cache on the basis of whether or not the result of the secure computation step is personally identifiable information.

22. The non-transient computer readable medium storing the secure computation program according to claim 15, wherein
the secure computation Program determines whether to store the result of the secure computation step in the secured cache or in the normal cache on the basis of whether or not the result of the secure computation step satisfies k-anonymity.

23. The non-transient computer readable medium storing the secure computation program according to claim 15, wherein
the secure computation Program determines whether to store the result of the secure computation step in the secured cache or in the normal cache on the basis of whether or not the result of the secure computation step satisfies l-diversity.

24. The non-transient computer readable medium storing the secure computation program according to claim 15, wherein
the secure computation program determines whether to store data in the secured cache or in the normal cache using a threshold value according to the capacity of the secured cache.

25. The secure computation program according to claim 15, wherein
the secure computation program makes a determination so as to preferentially store data that requires a long processing time for the computation process in the secured cache.
